(19) United States
(12) Patent Application Publication
(10) Pub. No.: US 2021/0318044 A1
(43) Pub. Date: Oct. 14, 2021

(54) SYSTEM AND METHOD FOR PERFORMANCE ESTIMATION OF A CHILLER PLANT

(71) Applicant: Carrier Corporation, Palm Beach Gardens, FL (US)

(72) Inventors: Yuan Yuan, Shanghai (CN); Lina Yang, Shanghai (CN); Jialong Wang, Shanghai (CN); Jinlei Ding, Shanghai (CN)

(21) Appl. No.: 17/058,425

(22) PCT Filed: Jul. 9, 2019
(86) PCT No.: PCT/US2019/040985

§ 371 Date: Nov. 24, 2020

(30) Foreign Application Priority Data
Jul. 16, 2018 (CN) 201810776861.7

(51) Int. Cl. F25B 49/00; F24F 11/62; G05B 19/4155

(52) U.S. Cl. CPC F25B 49/00; G05B 2219/50333; G05B 19/4155; F24F 11/62

(57) ABSTRACT

The present disclosure relates to a system and a method for prediction of chiller station performance. The method for prediction of chiller station performance includes: obtaining a temperature ECHWT of chilled water entering a first chiller in a chilled water circuit; obtaining a temperature LCHWT of chilled water leaving the first chiller in the chilled water circuit; obtaining a flow rate F1 of chilled water passing through the first chiller; obtaining a temperature LCWT of cooling water leaving the first chiller in a cooling water circuit; obtaining a power P1 of the first chiller; and training a first chiller performance model associated with variables COP, Q1e, LCHWT and LCWT based on obtained data COP, Q1e, LCHWT and LCWT; and predicting performance of the first chiller based on the first chiller performance model.

### FIELD OF THE INVENTION

The present disclosure relates to the field of chiller station, and in particular, to the field of performance recordation and prediction of devices in a chiller station.

### BACKGROUND OF THE INVENTION

For a chiller station, after many years of operation, performances of such devices as chiller, cooling tower and pump will become deviated from initial design performances thereof. For example, power consumption would be increased. During the operation of this type of chiller station that has been running for many years, it is necessary to know about actual operating conditions of these devices to configure an optimal control strategy. On the other hand, if the chiller station is to be retrofitted, it is also necessary to know about current actual operating conditions of the devices in the chiller station.

### SUMMARY OF THE INVENTION

An object of the present disclosure is to solve or at least alleviate the problems in the prior art.

An object of the present disclosure is to train a model that can reflect the real behavior of a chiller station, based on historical operating parameters of the chiller station.

An object of the present disclosure is to optimize a control strategy of a chiller station by using the model.

An object of the present disclosure is to use the model to predict the behavior, such as energy consumption, of a chiller station under a new working condition that has not occurred in history, thereby evaluating a chiller station retrofit plan.

A further object of the disclosure is to optimize the model to improve accuracy of the prediction.

A further object of the present disclosure is to estimate a flow rate of each chiller station or cooling tower based on total flow rates.

In one aspect, a system for prediction of chiller station performance is provided, including:

a sensor device that communicates with a controller, including:

a first temperature sensor which measures a temperature ECHWT of chilled water entering a first chiller in a chilled water circuit;

a second temperature sensor which measures a temperature LCHWT of chilled water leaving the first chiller in the chilled water circuit;

a flow meter which measures a total flow rate F of chilled water in the chilled water circuit or a flow rate F₁ of chilled water passing through the first chiller;

a third temperature sensor which measures a temperature LCWT of cooling water leaving the first chiller in a cooling water circuit;

a first power meter which measures a power P₁ of the first chiller; and

a controller which estimates the flow rate F₁ of chilled water passing through the first chiller based on the total flow rate F of chilled water, or directly obtains the flow rate F₁ of chilled water passing through the first chiller.

The controller, according to a formula:

Q₁ₑ=F₁×c×(ECHWT−LCHWT)

obtains a load Q₁ₑ of the first chiller, and, according to a formula:

COP=Q₁ₑ/P₁

obtains a performance coefficient COP of the first chiller;

and, the controller has a built-in first chiller performance model associated with variables COP, Q₁ₑ, LCHWT and LCWT:

COP=f(Q₁ₑ,LCHWT,LCWT)

and the controller trains the first chiller performance model based on obtained data COP, Q₁ₑ, LCHWT and LCWT.

and the controller predicts performance of the first chiller based on the first chiller performance model.

In another aspect, the present disclosure further provides a method for prediction of chiller station performance, including:

obtaining a temperature ECHWT of chilled water entering a first chiller in a chilled water circuit;

obtaining a temperature LCHWT of chilled water leaving the first chiller in the chilled water circuit;

obtaining a total flow rate F of chilled water in the chilled water circuit, and estimating a flow rate F₁ of chilled water passing through the first chiller based on the total flow rate F of chilled water or directly obtaining the flow rate F₁ of chilled water passing through the first chiller;

obtaining a temperature LCWT of cooling water leaving the first chiller in a cooling water circuit;

obtaining a power P₁ of the first chiller;

according to a formula:

Q₁ₑ=F₁×c×(ECHWT−LCHWT)

obtaining a load Q₁ₑ of the first chiller, and, according to a formula:

COP=Q₁ₑ/P₁

obtaining a performance coefficient COP of the first chiller; and

training a first chiller performance model associated with variables COP, Q₁ₑ, LCHWT and LCWT based on obtained data COP, Q₁ₑ, LCHWT and LCWT:

COP=f(Q₁ₑ,LCHWT,LCWT); and

predicting performance of the first chiller based on the first chiller performance model.

In another aspect, a method of estimating a chilled water flow rate Fᵢ of a i^{th} chiller in a chiller station is provided, the chiller station including n branches connected in parallel and n chillers distributed on the n branches;

the method including:

obtaining a temperature ECHWTᵢⱼ of chilled water entering each chiller and a temperature LCHWTᵢⱼ of chilled water leaving each chiller under n different total loads Qⱼ under a certain working condition, and calculating a temperature difference ΔTᵢⱼ=ECHWTᵢⱼ−LCHWTᵢⱼ between inlet water and outlet water of each chiller, wherein i represents an i^{th} chiller, which can take 1, 2 . . . n, j represents a j^{th} total load Qⱼ, which can take 1, 2 . . . n;

the method includes: according to equations:

$$( {Q}_{1} + {x}_{1} ) / c = {F}_{1} \cdot Δ {T}_{11} + {F}_{2} \cdot Δ {T}_{21} + … {F}_{n} \cdot Δ {T}_{n 1} \\ ( {Q}_{2} + {x}_{1} ) / c = {F}_{1} \cdot Δ {T}_{12} + {F}_{2} \cdot Δ {T}_{22} + … {F}_{n} \cdot Δ {T}_{n 2}$$

$$… \\ ( {Q}_{n} + {x}_{1} ) / c = {F}_{1} \cdot Δ {T}_{1 n} + {F}_{2} \cdot Δ {T}_{2 n} + … {F}_{n} \cdot Δ {T}_{n n}$$

determining a flow rate Fi of chilled water passing through the i^{th} chiller under the working condition.

In another aspect, a method for estimating a flow rate fᵢ of cooling water passing through an i^{th} cooling tower in a chiller station is provided, a cooling water circuit of the chiller station including m branches connected in parallel and m cooling towers distributed on the m branches;

the method including:

obtaining a temperature ECTWTᵢⱼ of cooling water entering each cooling tower and a temperature LCTWTᵢⱼ of cooling water leaving each cooling tower under m different total loads qⱼ under a certain working condition, and

calculating a temperature difference Δtᵢⱼ=ECTWTᵢⱼ−LCTWTᵢⱼ between inlet water and outlet water of each cooling tower under m different total loads qⱼ under the working condition,

wherein i represents the i^{th} cooling tower, which can take 1, 2 . . . m, and

j represents the j^{th} total load qⱼ, which can take 1, 2 . . . m;

the method includes: according to equations:

$$( {q}_{1} + {x}_{2} ) / c = {f}_{1} \cdot Δ {t}_{11} + {f}_{2} \cdot Δ {t}_{21} + … {f}_{m} \cdot Δ {t}_{m 1} \\ ( {q}_{2} + {x}_{2} ) / c = {f}_{1} \cdot Δ {t}_{12} + {f}_{2} \cdot Δ {t}_{22} + … {f}_{m} \cdot Δ {t}_{m 2}$$

$$… \\ ( {q}_{m} + {x}_{2} ) / c = {f}_{1} \cdot Δ {t}_{1 m} + {f}_{2} \cdot Δ {t}_{2 m} + … {f}_{m} \cdot Δ {t}_{m m}$$

determining a flow rate fᵢ of cooling water passing through each cooling tower under the working condition.

The system and method for prediction of chiller station performance according to the present disclosure are highly accurate, and can be used to optimize a control strategy of the chiller station and retrofit of the chiller station.

### BRIEF DESCRIPTION OF THE DRAWINGS

The contents of the present disclosure will become more easily understood with reference to the accompanying drawings. Those skilled in the art can readily appreciate that the drawings are for illustrative purposes only, instead of being intended to limit the scope of protection of the present disclosure. In addition, similar numbers in the drawings are used to indicate similar parts, wherein:

FIG. 1 shows a schematic structural view of a chiller station according to an embodiment; and

FIG. 2 shows a schematic structural view of a chiller station according to another embodiment.

### DETAILED DESCRIPTION OF THE EMBODIMENT(S) OF THE INVENTION

It will be readily understood that, based on the technical solutions of the present disclosure, those skilled in the art can propose various alternative embodiments and implementations without departing from the true spirit of the present disclosure. Therefore, the following detailed description and the accompanying drawings are merely exemplary description of the technical solutions of the present disclosure, which shall not be deemed as the whole of the present disclosure or as limiting or restricting the technical solutions of the present disclosure.

Such orientation terms as top, bottom, left, right, front, rear, front side, back side, top, bottom and so on that are mentioned or may be mentioned in this description are defined with respect to the configurations shown in the individual drawings. They are relative concepts and thus possibly vary according to their different locations and different usage states. Therefore, these or other orientation terms shall not be interpreted as limiting terms.

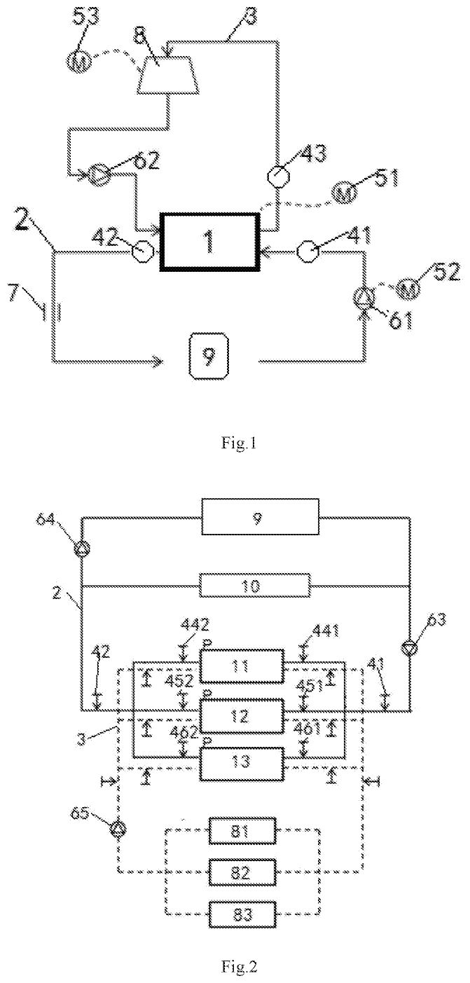

FIG. 1 shows a schematic structural view of a chiller station according to an embodiment. The chiller station mainly includes a chiller 1, a chilled water circuit 2 and a cooling water circuit 3. Heat exchange of chilled water and cooling water occurs in the chiller 1. A load 9 and a chilled water pressure pump 61 are provided in the chilled water circuit 2. A cooling tower 8 and a cooling water pressure pump 62 are provided in the cooling water circuit 3, cooling water releases heat at the cooling tower 8, and a plurality of blowers are provided in the cooling tower 8 to dissipate heat of the cooling water into ambient environment. Performances of various devices of this type of chiller station will change after long-term use, thus deviating from the rated data.

In order to accurately know the actual performance of each device for implementation of an optimal control strategy or for retrofit, maintenance or the like of the chiller station, the present disclosure provides a system for prediction of chiller station performance, including: a controller and a sensor device in communication with the controller. The sensor device collects relevant data and provide the same to the controller. The controller has a built-in model related to the data. With the data being continuously collected and updated, the controller trains parameters in the relevant model and thereby predicts corresponding changes of other data when part of the data changes, to acquire actual/real performance of the device. These real-performance data can be used to provide optimized control strategy or to predict behavior, such as energy consumption, of devices during working conditions have not occurred before and can serve as references for retrofit of chiller stations.

In an embodiment of the present disclosure, the sensor device can include: a first temperature sensor 41 which measures a temperature ECHWT of chilled water entering a first chiller 1 in a chilled water circuit 2; a second temperature sensor 42 which measures a temperature LCHWT of chilled water leaving the first chiller 1 in the chilled water circuit 2; a flow meter 7 which measures a total flow rate F of chilled water in the chilled water circuit or a flow rate F₁ of chilled water passing through the first chiller 1 (in the embodiment of FIG. 1, since only the first chiller 1 is provided, the total flow rate F of chilled water is equal to the flow rate F₁ of chilled water passing through the first chiller 1); a third temperature sensor 43 which measures a temperature LCWT of cooling water leaving the first chiller in a cooling water circuit 3; and a first power meter 51 which measures a power P₁ of the first chiller. In an alternative embodiment, the sensor device can include more elements to collect more data.

The controller is connected to these collection units to obtain the above data. Specifically, the controller can obtain the flow rate F₁ of chilled water passing through the first chiller or estimate the flow rate F₁ of chilled water passing through the first chiller based on the total flow rate F of chilled water;

The controller, according to the formula:

Q₁ₑ=F₁×c×(ECHWT−LCHWT)

obtains a load Q₁ₑ of the first chiller, wherein c represents specific heat of water, and, according to a formula:

COP=Q₁ₑ/P₁

obtains a performance coefficient COP of the first chiller;

and, the controller has a built-in first chiller performance model associated with variables COP, Q₁ₑ, LCHWT and LCWT:

COP=f(Q₁ₑ,LCHWT,LCWT)

and the controller trains the first chiller performance model based on obtained data COP, Q₁ₑ, LCHWT and LCWT;

and, the controller predicts performance of the first chiller based on the first chiller performance model. The controller continuously updates the coefficients in the first chiller performance model by using the obtained data COP, Q₁ₑ, LCHWT and LCWT, to obtain a first chiller performance model associated with the actual operational performance of the first chiller. According to the first chiller performance model, it is possible to estimate corresponding changes of other data when part of the data changes. For example, the first chiller performance model can be used to predict energy consumption of the first chiller under different loads. In some embodiments, the first chiller performance model is also related to rated load Q₁ᵣ of the first chiller. In some embodiments, the first chiller performance model can be a semi-physical model derived from the first and second laws of thermodynamics. It, based on the principles of energy conservation and entropy balance, is a function of three independent variables, including cooling capacity of a chiller evaporator, water temperature at an evaporator outlet, and water temperature at a condenser outlet.

In a further embodiment, the sensor device can include a second power meter 53 that measures fan power P₂ of a first cooling tower 8 in the cooling water circuit 3.

The controller also collects fan speed data SPD of the first cooling tower, which can be directly obtained based on a control signal.

The controller has a built-in fan power model of the first cooling tower, which is associated with variables P₂ and SPD:

P₂=f(SPD)

and, the controller trains the fan power model of the first cooling tower based on the obtained data P₂ and SPD.

and, the controller predicts performance of the first cooling tower fan based on the fan power model of the cooling tower. In some embodiments, the fan power model of the first cooling tower is also related to a rated maximum speed SPDᵣ of the first cooling tower fan and a rated maximum power P₂ᵣ of the first cooling tower fan.

In some embodiments, the fan power model of the first cooling tower is:

$$\frac{{P}_{2}}{{P}_{2 r}} = {b}_{1} \cdot {N}_{fan} + {b}_{2} \cdot {N}_{fan}^{2} + {b}_{3} \cdot {N}_{fan}^{3}$$

$$where$$

$${N}_{fan} = \frac{S P D}{S P {D}_{r}}$$

and, the controller trains values of coefficients b₁, b₂, and b₃ by using the obtained data P₂ and SPD. The fan power model of the first cooling tower can be used to predict power consumption of the cooling tower at different fan speeds.

In some embodiments, the sensor device further includes: a third power meter 52 that measures a power P₃ of a chilled water pressure pump 61 in the chilled water circuit 2; and the controller also obtains a working flow rate Qₒₚ of the chilled water pressure pump and rotational speed n of the chilled water pressure pump;

the controller has a built-in power model of the chilled water pressure pump, which is associated with variables P₃, Qₒₚ and n:

P₃=f(Qₒₚ,n)

and, the controller trains the power model of the chilled water pressure pump based on the obtained data P₃, Qₒₚ, and n;

and, the controller predicts performance of the chilled water pressure pump based on the power model of the chilled water pressure pump. In some embodiments, the power model of the chilled water pressure pump is also related to a designed rated flow rate Q_{des} of the chilled water pressure pump and a rated power P_{des} of the chilled water pressure pump.

In some embodiments, the power model of the chilled water pressure pump is:

Pₒₚ/P_{des}=a₁+a₂·R_{MFR}+a₃·n+a₄·R_{MFR}²+a₅·n²+a₆·R_{MFR}·n

where

R_{MFR}=Qₒₚ/Q_{des}

and, the controller trains values of coefficients a₁, a₂, a₃, a₄, a₅, and a₆ based on the obtained data P₃, Qₒₚ, and n. Power consumption of the chilled water pressure pump at a particular Qₒₚ and n can be predicted accurately by means of the power model of the chilled water pressure pump.

In some embodiments, the controller further obtains data of an ambient temperature, a water flow rate, a fan air volume, and an inlet water temperature of the first cooling tower 8; the controller further includes a built-in effective heat transfer unit number model ⋅-NTU associated with the ambient temperature, the water flow rate, the fan air volume and the inlet water temperature of the first cooling tower; the controller also trains the effective heat transfer unit number model based on the obtained data of the ambient temperature, the water flow rate, the fan air volume, and the inlet water temperature of the first cooling tower; and the controller predicts an outlet water temperature of the first cooling tower based on the effective heat transfer unit number model.

With continued reference to FIG. 2, another embodiment of the present disclosure is illustrated. In this embodiment, the chiller station includes three branches connected in parallel and three chillers distributed on the three branches, referred to as a first chiller 11, a second chiller 12, and a third chiller 13, respectively. A first temperature sensor 41 and a second temperature sensor 42 are arranged in the chilled water circuit 2, and in each branch, temperature sensors are arranged upstream and downstream of each chiller, including temperature sensors 441, 442 upstream and downstream of the first chiller 11, temperature sensors 451, 452 upstream and downstream of the second chiller 12, and temperature sensors 461, 462 upstream and downstream of the third chiller 13. The chilled water circuit 2 further includes a bypass valve 10, a load 9, a first chilled water pressure pump 63, and a second chilled water pressure pump 64. In this embodiment, it is difficult and expensive to obtain a flow rate of each chiller by separately installing a flow meter in each branch. Accordingly, in some embodiments of the present disclosure, the flow meter is provided in the overall flow path only, and the controller obtains the total flow rate F and estimates the flow rate Fᵢ of each branch. Specifically, in the case of three branches, the controller obtains a temperature ECHWTᵢⱼ of chilled water entering each chiller and a temperature LCHWTᵢⱼ of chilled water leaving each chiller under three different total loads Qⱼ under a certain working condition, and calculates a temperature difference ΔTᵢⱼ=ECHWTᵢⱼ−LCHWTᵢⱼ of inlet water and outlet water of each chiller, where i represents the i^{th} chiller, which may take 1, 2 or 3, and j represents the j^{th} total load Qⱼ, which may take 1, 2 or 3;

By the following, the controller:

(Q₁+x₁)/c=F₁·ΔT₁₁+F₂·ΔT₂₁+F₃·ΔT₃₁

(Q₂+x₁)/c=F₁·ΔT₁₂+F₂·ΔT₂₂+F₃·ΔT₃₂

(Q₃+x₁)/c=F₁·ΔT₁₃+F₂˜ΔT₂₃+F₃·ΔT₃₃

The equations are based on the principle of energy conservation where c represents specific heat and x₁ is a compensation parameter, which can be an empirical parameter considering such other factors as heat loss of pipeline, and heat sources in system, e.g., pump heat generation. In some cases, said other factors can be ignored, that is, x₁ can take zero. The controller, by solving the above equations, can obtain a flow rate F₁ of chilled water passing through the first chiller 1, a flow rate F₂ of chilled water passing through the second chiller, and the flow rate F₃ of chilled water passing through the third chiller, under said working condition. The same working condition refers to a condition where the flow rate of each branch has not changed, and for a chiller station with a plurality of branches, the working condition may be changed if there is any change in physical structure, e.g., change of pipeline mode and valve opening such as opening and closing of the bypass valve 10, and opening or closing of the chiller. In the operation under the same working condition, the chiller often has a variety of total load data. The controller can estimate the flow rate of each branch by merely selectively collecting the data under various working conditions. The flow rate of each branch can also be used to evaluate performance of each branch in addition to the above model analysis, or to determine whether the branch is abnormal in flow rate or whether the water pump is abnormal, according to data of the flow rate. On the other hand, after the working condition is changed, the flow rate of each flow path should be re-estimated by the above method with respect to the three sets of different total loads Qⱼ for the new working conditions. It should be understood that Qⱼ=F×c×(ECHWT−LCHWT), where F is the total flow rate, and ECHWT and LCHWT are the temperatures of chilled water entering the chiller station set and that leaving the chiller station set, respectively, which are obtained by the first temperature sensor 41 and the second temperature sensor 42, respectively. Additionally, in some embodiments, in order to make the obtained data of estimated flow rate more accurate, a difference between any two total loads Qⱼ under the same working condition should be more than 5%. If two total loads Qⱼ are close to each other, there will be a deviation between the estimated data of flow rates of individual branches. In addition, it should be understood that the same principle can be applied to the case where n chillers are distributed in n branches, in which case it would be necessary to obtain data under n kinds of loads Qⱼ under the same working condition to solve the equation.

With continued reference to FIG. 2, in some embodiments, in the cooling water circuit 3 labeled by the dashed line, there may be a plurality of cooling towers, such as a first cooling tower 81, a second cooling tower 82, and a third cooling tower 83. For the flow rate of each cooling tower, since total heat released by the system is finally discharged from the cooling water side, the total load on the cooling water side is also known, and the total dissipated heat of the cooling tower is equal to the heat generated by the chiller and the cooling water pressure pump 65. Therefore, the flow rate of each branch can also be calculated by the above method according to the flow rate of the main flow path for evaluation of whether the flow rate of each cooling water branch is abnormal or for other analysis. Specifically, the method for calculating the flow rate of each cooling tower includes: obtaining a temperature ECTWTᵢⱼ of cooling water entering each cooling tower and a temperature LCTWTᵢⱼ of cooling water leaving each cooling tower under three different total loads qⱼ under a certain working condition, and calculating a temperature difference Δtᵢⱼ=ECTWTᵢⱼ−LCTWTᵢⱼ between inlet water and outlet water of each cooling tower under the three different total loads qⱼ under the working condition, where i represents the i^{th} cooling tower, which can take 1, 2 or 3, and j represents the j^{th} kind of total load qⱼ, which can take 1, 2 or 3;

The method includes: through the following equations:

(q₁+x₂)/c=f₁·Δt₁₁+f₂·Δt₂₁+f₃·Δt₃₁

(q₂+x₂)/c=f₁·Δt₁₂+f₂·Δt₂₂+f₃·Δt₃₂

(q₃+x₂)/c=f₁·Δt₁₃+f₂·Δt₂₃+f₃·Δt₃₃

determining a flow rate fᵢ of cooling water passing through each cooling tower under the working condition. In the above equations, c represents specific heat and x₂ is a compensation constant considering such factors as heat loss of pipeline, and heat sources in system, e.g., cooling water pressure pump 65, which can be obtained upon experiences and also can take zero. In addition, in some embodiments, in order to make the obtained data of estimated flow rate more accurate, a difference between any two total loads qⱼ under the same working condition should be more than 5%. If two total loads qⱼ are close to each other, there will be a deviation between the estimated data of flow rates of individual branches. In addition, it should be understood that the method can be applied to the case where the cooling water circuit includes m branches, in which case it would be necessary to obtain data under m kinds of loads qⱼ under the same working condition to solve the equation.

In some other embodiments, a method for prediction of chiller station performance is also provided, including:

obtaining a temperature ECHWT of chilled water entering a first chiller in a chilled water circuit;

obtaining a temperature LCHWT of chilled water leaving the first chiller in the chilled water circuit;

obtaining a total flow rate F of chilled water in the chilled water circuit, and estimating a flow rate F₁ of chilled water passing through the first chiller based on the total flow rate F of chilled water or directly obtaining the flow rate F₁ of chilled water passing through the first chiller;

obtaining a temperature LCWT of cooling water leaving the first chiller in a cooling water circuit;

obtaining a power P₁ of the first chiller; and

according to a formula:

Q₁ₑ=F₁×c×(ECHWT−LCHWT)

obtaining a load Q₁ₑ of the first chiller, where c represents specific heat of water, and, according to a formula:

COP=Q₁ₑ/P₁

obtaining a performance coefficient COP of the first chiller;

and, training a first chiller performance model associated with variables COP, Q₁ₑ, LCHWT and LCWT based on obtained data COP, Q₁ₑ, LCHWT and LCWT:

COP=f(Q₁ₑ,LCHWT,LCWT)

and, predicting performance of the first chiller based on the first chiller performance model.

In some embodiments, the first chiller performance model is also related to a rated load Q₁ᵣ of the first chiller.

In some embodiments, the method:

obtains a fan power P₂ of a first cooling tower in the cooling water circuit;

obtains data of fan speed SPD of the first cooling tower;

trains a fan power model of the first cooling tower which is associated with variables P₂ and SPD based on the obtained data P₂ and SPD:

P₂=f(SPD)

and, predicts performance of the fan of the first cooling tower based on the fan power model of the first cooling tower.

In some embodiments, the fan power model of the first cooling tower is further related to a rated maximum fan speed SPDᵣ of the first cooling tower and a rated maximum fan power P₂ᵣ of the first cooling tower.

In some embodiments, the fan power model of the first cooling tower is:

$$\frac{{P}_{2}}{{P}_{2 r}} = {b}_{1} \cdot {N}_{fan} + {b}_{2} \cdot {N}_{fan}^{2} + {b}_{3} \cdot {N}_{fan}^{3}$$

$$where$$

$${N}_{fan} = \frac{S P D}{S P {D}_{r}}$$

the method includes training values of coefficients b₁, b₂, and b₃ by using the obtained data P₂ and SPD.

In some embodiments, the method includes:

obtaining a power P₃ of a chilled water pressure pump in the chilled water circuit;

obtaining a working flow rate Qₒₚ of the chilled water pressure pump and a rotational speed n of the chilled water pressure pump;

training the power model of the chilled water pressure pump associated with variables P₃, Qₒₚ and n based on the obtained data P₃, Qₒₚ and n:

P₃=f(Qₒₚ,n)

and, predicting performance of the chilled water pressure pump based on the power model of the chilled water pressure pump.

In some embodiments, the power model of the chilled water pressure pump is also related to a designed rated flow rate Q_{des} of the chilled water pressure pump and a rated power P_{des} of the chilled water pressure pump.

In some embodiments, the power model of the pressure pump is:

Pₒₚ/P_{des}=a₁+a₂·R_{MFR}+a₃·n+a₄·R_{MFR}²+a₅·n²+a₆·R_{MFR}·n

where

R_{MFR}=Qₒₚ/Q_{des}

the method includes training values of coefficients a₁, a₂, a₃, a₄, a₅, and a₆ based on the obtained data P₃, Qₒₚ and n.

In some embodiments, the method includes:

obtaining data of an ambient temperature, a water flow rate, a fan air volume, and an inlet water temperature of the first cooling tower;

based on the obtained data of the ambient temperature, the water flow rate, the fan air volume and the inlet water temperature of the first cooling tower, training an effective heat transfer unit number model □-NTU associated with the ambient temperature, the water flow rate, the fan air volume and the inlet water temperature of the first cooling tower; and

predicting an outlet water temperature of the first cooling tower based on the effective heat transfer unit number model.

In some embodiments, the chiller station includes n branches connected in parallel and n chillers distributed in the n branches;

the method includes:

obtaining a temperature ECHWTᵢⱼ of chilled water entering each chiller and a temperature LCHWTᵢⱼ of chilled water leaving each chiller under n different total loads Qⱼ under a certain working condition, and calculating a temperature difference ΔTᵢⱼ=ECHWTᵢⱼ−LCHWTᵢⱼ between inlet water and outlet water of each chiller, wherein i represents the i^{th} chiller, which can take 1, 2 . . . n, and j represents the j^{th} total load Qⱼ, which can take 1, 2 . . . n;

the method includes: according to equations:

$$( {Q}_{1} + {x}_{1} ) / c = {F}_{1} \cdot Δ {T}_{11} + {F}_{2} \cdot Δ {T}_{21} + … {F}_{n} \cdot Δ {T}_{n 1} \\ ( {Q}_{2} + {x}_{1} ) / c = {F}_{1} \cdot Δ {T}_{12} + {F}_{2} \cdot Δ {T}_{22} + … {F}_{n} \cdot Δ {T}_{n 2}$$

$$… \\ ( {Q}_{n} + {x}_{1} ) / c = {F}_{1} \cdot Δ {T}_{1 n} + {F}_{2} \cdot Δ {T}_{2 n} + … {F}_{n} \cdot Δ {T}_{n n}$$

determining a flow rate Fᵢ of chilled water passing through the i^{th} chiller under the working condition.

In some embodiments, the cooling water circuit of the chiller station includes m branches connected in parallel and m cooling towers distributed in the m branches;

the method includes:

obtaining a temperature ECTWTᵢⱼ of cooling water entering each cooling tower and a temperature LCTWTᵢⱼ of cooling water leaving each cooling tower under m different total loads qⱼ under a certain working condition, and

calculating a temperature difference Δtᵢⱼ=ECTWTᵢⱼ−LCTWTᵢⱼ between inlet water and outlet water of each cooling tower under m different total loads qⱼ under the working condition,

wherein i represents the i^{th} cooling tower, which can take 1, 2 . . . m, and

j represents the j^{th} total load qⱼ, which can take 1, 2 . . . m;

the method includes: according to equations:

$$( {q}_{1} + {x}_{2} ) / c = {f}_{1} \cdot Δ {t}_{11} + {f}_{2} \cdot Δ {t}_{21} + … {f}_{m} \cdot Δ {t}_{m 1} \\ ( {q}_{2} + {x}_{2} ) / c = {f}_{1} \cdot Δ {t}_{12} + {f}_{2} \cdot Δ {t}_{22} + … {f}_{m} \cdot Δ {t}_{m 2}$$

$$… \\ ( {q}_{m} + {x}_{2} ) / c = {f}_{1} \cdot Δ {t}_{1 m} + {f}_{2} \cdot Δ {t}_{2 m} + … {f}_{m} \cdot Δ {t}_{m m}$$

determining a flow rate fᵢ of cooling water passing through each cooling tower under the working condition.

The specific embodiments described above are merely for describing the principle of the present disclosure more clearly, and various components are clearly illustrated or depicted to make it easier to understand the principle of the present disclosure. Those skilled in the art can readily make various modifications or changes to the present disclosure without departing from the scope of the present disclosure. It should be understood that these modifications or changes should be included within the scope of protection of the present disclosure.

1. A system for prediction of chiller station performance, comprising:
a sensor device, comprising:
a first temperature sensor configured to measure a temperature ECHWT of chilled water entering a first chiller in a chilled water circuit;
a second temperature sensor configured to measure a temperature LCHWT of chilled water leaving the first chiller in the chilled water circuit;
a flow meter configured to measure at least one of a total flow rate F of chilled water in the chilled water circuit and a flow rate F1 of chilled water passing through the first chiller;
a third temperature sensor configured to measure a temperature LCWT of cooling water leaving the first chiller in a cooling water circuit; and
a first power meter configured to measure a power P₁ of the first chiller; and
a controller configured to communicate with the sensor device, and at least one of configured to estimate the flow rate F₁ of chilled water passing through the first chiller based on the total flow rate F of chilled water, and directly obtain the flow rate F1 of chilled water passing through the first chiller;
the controller, according to a formula:
Q₁ₑ=F₁×c×(ECHWT−LCHWT)
obtains a load Q₁ₑ of the first chiller, where c is specific heat of water, and according to a formula:
COP=Q₁ₑ/P₁
obtains a performance coefficient COP of the first chiller;
and, the controller has a built-in first chiller performance model associated with variables COP, Q₁ₑ, LCHWT and LCWT:
COP=f(Q₁ₑ,LCHWT,LCWT)
and, the controller is configured to train the first chiller performance model based on obtained data COP, Q₁ₑ, LCHWT and LCWT; and,
the controller is configured to predict performance of the first chiller based on the first chiller performance model.

2. The system for prediction of chiller station performance according to claim 1, wherein the first chiller performance model is further related to a rated load Q₁ᵣ of the first chiller.

3. The system for prediction of chiller station performance according to claim 1, wherein the sensor device comprises:
a second power meter that measures a fan power P₂ of a first cooling tower in the cooling water circuit; and
the controller is configured to collect fan speed data SPD of the first cooling tower;
the controller including a built-in fan power model of the first cooling tower associated with variables P₂ and SPD;
P₂=f(SPD)
and, the controller is configured to train the fan power model of the first cooling tower based on the obtained data P2 and SPD; and,
the controller is configured to predict performance of the first cooling tower fan based on the fan power model of the first cooling tower.

4. The system for prediction of chiller station performance according to claim 3, wherein the fan power model of the first cooling tower is further related to a rated maximum rotational speed SPDᵣ of the first cooling tower fan and a rated maximum fan power P₂ᵣ of the first cooling tower.

5. The system for prediction of chiller station performance according to claim 3, wherein the fan power model of the first cooling tower is:
$$\frac{{P}_{2}}{{P}_{2 r}} = {b}_{1} \cdot {N}_{fan} + {b}_{2} \cdot {N}_{fan}^{2} + {b}_{3} \cdot {N}_{fan}^{3}$$
$$where$$
$${N}_{fan} = \frac{S P D}{S P {D}_{r}}$$
and the controller is configured to train values of coefficients b₁, b₂, and b₃ by using the obtained data P₂ and SPD.

6. The system for prediction of chiller station performance according to claim 1, wherein the sensor device comprises:
a third power meter that measures a power P₃ of a chilled water pressure pump in the chilled water circuit; and
the controller is configured to obtain a working flow rate Qₒₚ of the chilled water pressure pump and a rotational speed n of the chilled water pressure pump;
the controller has a built-in chilled water pressure pump power model associated with variables P₃, Qₒₚ and n:
P₃=f(Qₒₚ,n)
and, the controller is configured to train the chilled water pressure pump power model based on the obtained data P₃, Qₒₚ, and n;
and, the controller is configured to predict performance of the chilled water pressure pump based on the chilled water pressure pump power model.

7. The system for prediction of chiller station performance according to claim 6, wherein the chilled water pressure pump power model is also related to a designed rated flow rate Q_{des} of the chilled water pressure pump and a rated power P_{des} of the chilled water pressure pump.

8. The system for prediction of chiller station performance according to claim 6, wherein the chilled water pressure pump power model is:
Pₒₚ/P_{des}=a₁+a₂·R_{MFR}+a₃·n+a₄·R_{MFR}²+a₅·n²+a₆·R_{MFR}·n
where
R_{MFR}=Qₒₚ/Q_{des}
and the controller is configured to train values of coefficients a₁, a₂, a₃, a₄, a₅, and a₆ based on the obtained data P₃, Qₒₚ and n.

9. The system for prediction of chiller station performance according to claim 1, wherein the controller is configured to obtain data of an ambient temperature, a water flow rate, a fan air volume, and an inlet water temperature of a first cooling tower;
the controller having a built-in effective heat transfer unit number model □-NTU associated with the ambient temperature, the water flow rate, the fan air volume and the inlet water temperature of the first cooling tower;
the controller is configured to train the effective heat transfer unit number model based on the obtained data of the ambient temperature, the water flow rate, the fan air volume, and the inlet water temperature of the first cooling tower; and
the controller is configured to predict an outlet water temperature of the first cooling tower based on the effective heat transfer unit number model.

10. The system for prediction of chiller station performance according to claim 1, wherein the chiller station comprises n branches connected in parallel and n chillers distributed in the n branches;
wherein the controller is configured to obtain a temperature ECHWTᵢⱼ of chilled water entering each chiller and a temperature LCHWTᵢⱼ of chilled water leaving each chiller under n different total loads Qⱼ under a certain working condition, and
the controller is configured to calculate a temperature difference ΔTᵢⱼ=ECHWTᵢⱼ−LCHWTᵢⱼ between inlet water and outlet water of each chiller, where i represents the i^{th} chiller, which can take 1, 2 . . . n, and j represents the j^{th} total load Qⱼ, which can take 1, 2 . . . n;
the controller, according to equations:
$$( {Q}_{1} + {x}_{1} ) / c = {F}_{1} \cdot Δ {T}_{11} + {F}_{2} \cdot Δ {T}_{21} + … {F}_{n} \cdot Δ {T}_{n 1} \\ ( {Q}_{2} + {x}_{1} ) / c = {F}_{1} \cdot Δ {T}_{12} + {F}_{2} \cdot Δ {T}_{22} + … {F}_{n} \cdot Δ {T}_{n 2}$$
$$… \\ ( {Q}_{n} + {x}_{1} ) / c = {F}_{1} \cdot Δ {T}_{1 n} + {F}_{2} \cdot Δ {T}_{2 n} + … {F}_{n} \cdot Δ {T}_{n n}$$
determines a flow rate Fi of chilled water passing through the i^{th} chiller under the working condition, where x₁ is a compensation parameter.

11. A method for prediction of chiller station performance, comprising:
obtaining a temperature ECHWT of chilled water entering a first chiller in a chilled water circuit;
obtaining a temperature LCHWT of chilled water leaving the first chiller in the chilled water circuit;
obtaining a total flow rate F of chilled water in the chilled water circuit, and estimating a flow rate F₁ of chilled water passing through the first chiller based on the total flow rate F of chilled water or directly obtaining the flow rate F₁ of chilled water passing through the first chiller;
obtaining a temperature LCWT of cooling water leaving the first chiller in a cooling water circuit;
obtaining a power P₁ of the first chiller; and
according to a formula:
Q₁ₑ=F₁×c×(ECHWT−LCHWT)
obtaining a load Q₁ₑ of the first chiller, where c is specific heat of water, and according to a formula:
COP=Q₁ₑ/P₁
obtaining a performance coefficient COP of the first chiller;
and, training a first chiller performance model associated with variables COP, Q₁ₑ, LCHWT and LCWT based on obtained data COP, Q₁ₑ, LCHWT and LCWT:
COP=f(Q₁ₑ,LCHWT,LCWT)
and, predicting performance of the first chiller based on the first chiller performance model.

12. The method according to claim 11, wherein the first chiller performance model is further related to a rated load Q₁ᵣ of the first chiller.

13. The method according to claim 11, further comprising:
obtaining a fan power P₂ of a first cooling tower in the cooling water circuit;
obtaining fan speed data SPD of the first cooling tower;
training a fan power model of the first cooling tower associated with variables P₂ and SPD based on the obtained data P₂ and SPD:
P₂=f(SPD)
and, predicting performance of the first cooling tower fan based on the fan power model of the first cooling tower.

14. The method according to claim 13, wherein the fan power model of the first cooling tower is further related to a rated maximum rotational speed SPDᵣ of the first cooling tower fan and a rated maximum fan power P₂ᵣ of the first cooling tower.

15. The method according to claim 13, wherein the fan power model of the first cooling tower is:
$$\frac{{P}_{2}}{{P}_{2 r}} = {b}_{1} \cdot {N}_{fan} + {b}_{2} \cdot {N}_{fan}^{2} + {b}_{3} \cdot {N}_{fan}^{3}$$
$$where$$
$${N}_{fan} = \frac{S P D}{S P {D}_{r}}$$
and the method comprises training values of coefficients b₁, b₂, and b₃ by using the obtained data P₂ and SPD.

16. The method according to claim 11, wherein the method comprises:
obtaining a power P₃ of a chilled water pressure pump in the chilled water circuit;
obtaining a working flow rate Qₒₚ of the chilled water pressure pump and a rotational speed n of the chilled water pressure pump;
training a chilled water pressure pump power model associated with variables P₃, Qₒₚ and n based on the obtained data P₃, Qₒₚ and n:
P₃=f(Qₒₚ,n)
and, predicting performance of the chilled water pressure pump based on the chilled water pressure pump power model.

17. (canceled)

18. The method according to claim 16, wherein the pressure pump power model is:
Pₒₚ/P_{des}=a₁+a₂·R_{MFR}+a₃·n+a₄·R_{MFR}²+a₅·n²+a₆·R_{MFR}·n
where
R_{MFR}=Qₒₚ/Q_{des}
the method comprises training values of coefficients a₁, a₂, a₃, a₄, a₅, and a₆ based on the obtained data P₃, Qₒₚ and n.

19. The method according to claim 11, wherein the method comprises:
obtaining data of an ambient temperature, a water flow rate, a fan air volume, and an inlet water temperature of the first cooling tower;
based on the obtained data of the ambient temperature, the water flow rate, the fan air volume and the inlet water temperature of the first cooling tower, training an effective heat transfer unit number model □-NTU associated with the ambient temperature, the water flow rate, the fan air volume and the inlet water temperature of the first cooling tower; and
predicting an outlet water temperature of the first cooling tower based on the effective heat transfer unit number model.

20. The method according to claim 11, wherein
the chiller station comprises n branches connected in parallel and n chillers distributed in the n branches, and
the method comprises:
obtaining a temperature ECHWTᵢⱼ of chilled water entering each chiller and a temperature LCHWTᵢⱼ of chilled water leaving each chiller under n different total loads Qⱼ under a certain working condition, and calculating a temperature difference ΔTᵢⱼ=ECHWTᵢⱼ−LCHWTᵢⱼ between inlet water and outlet water of each chiller, where i represents the i^{th} chiller, which can take 1, 2 . . . n, and j represents the j^{th} total load Qⱼ, which can take 1, 2 . . . n;
the method comprises: according to equations:
$$( {Q}_{1} + {x}_{1} ) / c = {F}_{1} \cdot Δ {T}_{11} + {F}_{2} \cdot Δ {T}_{21} + … {F}_{n} \cdot Δ {T}_{n 1} \\ ( {Q}_{2} + {x}_{1} ) / c = {F}_{1} \cdot Δ {T}_{12} + {F}_{2} \cdot Δ {T}_{22} + … {F}_{n} \cdot Δ {T}_{n 2}$$
$$… \\ ( {Q}_{n} + {x}_{1} ) / c = {F}_{1} \cdot Δ {T}_{1 n} + {F}_{2} \cdot Δ {T}_{2 n} + … {F}_{n} \cdot Δ {T}_{n n}$$
determining a flow rate Fᵢ of chilled water passing through the i^{th} chiller under the working condition, where x₁ is a compensation parameter.

21. The method according to claim 11, wherein the cooling water circuit of the chiller station comprises m branches connected in parallel and m cooling towers distributed in the m branches;
the method comprises:
obtaining a temperature ECTWTᵢⱼ of cooling water entering each cooling tower and a temperature LCTWTᵢⱼ of cooling water leaving each cooling tower under m different total loads qⱼ under a certain working condition, and
calculating a temperature difference Δtᵢⱼ=ECTWTᵢⱼ−LCTWTᵢⱼ between inlet water and outlet water of each cooling tower under m different total loads qⱼ under the working condition,
where i represents the i^{th} cooling tower, which can take 1, 2 . . . m, and
j represents the j^{th} total load qⱼ, which can take 1, 2 . . . m;
the method comprises: according to equations:
$$( {q}_{1} + {x}_{2} ) / c = {f}_{1} \cdot Δ {t}_{11} + {f}_{2} \cdot Δ {t}_{21} + … {f}_{m} \cdot Δ {t}_{m 1} \\ ( {q}_{2} + {x}_{2} ) / c = {f}_{1} \cdot Δ {t}_{12} + {f}_{2} \cdot Δ {t}_{22} + … {f}_{m} \cdot Δ {t}_{m 2}$$
$$… \\ ( {q}_{m} + {x}_{2} ) / c = {f}_{1} \cdot Δ {t}_{1 m} + {f}_{2} \cdot Δ {t}_{2 m} + … {f}_{m} \cdot Δ {t}_{m m}$$
determining a flow rate fᵢ of cooling water passing through each cooling tower under the working condition, where x₂ is a compensation parameter.
